(19) United States
(12) Patent Application Publication
(10) Pub. No.: US 2009/0056357 A1
(43) Pub. Date: Mar. 5, 2009

(54) Air conditioner with service valve assembly

(76) Inventors: Seung Woo Kang, Seoul (KR); Chan Ho Song, Seoul (KR); Jae Hoon Sim, Seoul (KR)

Correspondence Address: MCKENNA LONG & ALDRIDGE LLP, 1900 K STREET, NW, WASHINGTON, DC, 20006, US

(21) Appl. No.: 12/230,251

(22) Filed: Aug. 26, 2008

(30) Foreign Application Priority Data
Aug. 29, 2007 (KR) 10-2007-0087199

(51) Int. Cl. F25D 23/00; F25B 1/00; F16K 1/00

(52) U.S. Cl. 62/259.1; 62/498; 251/318

(57) ABSTRACT

An air conditioner with a service valve assembly is disclosed wherein service valves are used for easy infusion and collection of refrigerant at the time of installation or detachment of separation-type multi-air conditioner mounted with a plurality of indoor units reducing the manufacturing costs and unit size. The air conditioner comprises: an outdoor unit including a compressor and heat exchanger; a plurality of indoor units including an expander and an indoor heat exchanger; a plurality of refrigerant input pipes; a first convergence piping for converging the refrigerant flowing in the plurality of refrigerant input pipes into the compressor; a second convergence piping for converging and introducing the refrigerant having passed the outdoor heat exchanger via the compressor into the plurality of indoor units; a plurality of refrigerant supply pipes; and first and second service valves for controlling fluid flow.

The present application is based on, and claims the benefit of, Korean Patent Application No. 10-2007-0087199, filed Aug. 29, 2007, the disclosure of which is hereby incorporated by reference herein in its entirety.

### BACKGROUND OF THE INVENTION

1. Field of the Invention

The following description relates generally to an air conditioner, and more particularly, to an air conditioner with a service valve assembly capable of easing the infusion and collection of refrigerant using a service valve at the time of installation or detachment of the separation-type multi-air conditioner mounted with a plurality of indoor units, to thereby reduce manufacturing cost and realize a compact size.

2. Discussion of the Related Art

Typically, an air conditioner is used to maintain temperature, humidity, or cleanliness, or the like, for use in rooms or areas, and to eliminate dust or harmful gas. In using the air conditioner as a cooling apparatus, the air conditioner forms a cycle of absorbing indoor heat to maintain an inside of a room at a low temperature, and then discharges the absorbed heat to the outside.

An air conditioner, as shown in FIG. 1, essentially comprises an outdoor unit 10 including a compressor 13 and an outdoor heat exchanger 16, and an indoor unit 20 including an expander 23 and an indoor heat exchanger 26.

Air conditioners may be roughly divided into an integral type (window type) and a separation-type (or split type) (also referred to herein as “separation-type multi-air conditioner”) according to an installation method of the outdoor unit 10 and indoor unit 20. The window type and separation-type air conditioners are functionally identical, but the former has one unit as a whole, where outdoor unit and indoor units are integrally disposed by way of drilling into a wall of a building or by hanging on a window sill to thereby integrate the functions of cooling and radiation. In other words, the former is such that a cooling unit and a heat discharge unit are integrated. The latter is such that radiation and compressing apparatus are installed outside of a room, area, or a building, while cooling apparatus are installed inside the room, area, or building, while refrigerant piping couples the outdoor unit 10 and the indoor units 20. In other words, the latter is such that one or more cooling units are disposed indoors and heat discharge and compressing units are disposed outdoors.

FIG. 2 is a perspective view illustrating an exterior of a separation-type air conditioner according to related art. FIG. 3 is a structural view illustrating a refrigerant circulation system according to an exemplary embodiment of FIG. 2. FIG. 4 is a side view illustrating a service valve installed at one side of an outdoor unit according to the exemplary embodiment of FIG. 2.

Referring to FIG. 2, a multi-type air conditioner is installed in separation-type in which an outdoor unit 10 is connected to a plurality of indoor units 20 allowing air cooling or heating in each indoor space. In other words, an outdoor unit 10 installed outside of a room or an area is connected to a plurality of indoor units 20, each indoor unit being installed inside, via refrigerant piping 30, such that more than two indoor units 20 are connected to a single outdoor unit 10 to control air in a plurality of indoor spaces and to suitably cope with an operation load of indoor units.

Referring to FIGS. 2 and 3, an outdoor unit 10 according to the related art has mounted on one side thereof a service valve 40. The service valve 40 is used during retrieval or collection of refrigerant. When an air conditioner is first installed on a building, refrigerant is infused thereinto, and the installed air conditioner is moved to another building. In other words, when an air conditioner is first installed on a building, an outdoor unit 10 is installed outside the building, indoor units 20 are installed inside the building, and the service valve 40 is opened to operate the air conditioner.

The process is such that when the air conditioner is moved to another building, the air conditioner is operated with the service valve 40 shut off to collect the refrigerant into a compressor 13, and the air conditioner is detached and installed in another building. Furthermore, the service valve 40 connectively functions such that refrigerant that has passed the indoor unit 20 is made to be introduced into a compressor 13, and the refrigerant having passed an outdoor heat exchanger 16 is re-supplied into the indoor unit 20.

Referring to FIGS. 3 and 4, the service valve 40 may be composed of a plural structure so as to be connected to each indoor unit 20 in one pair. In other words, the service valve 40 further comprises: a plurality of first service valves 43, each connected from the plurality of indoor units 20, to the compressor 13; and a plurality of second service valves 46 for introducing the refrigerant having passed through an outdoor heat exchanger 16 via the compressor 13 back into the indoor units 20. The first and second service valves 43, 46, respectively may alternatively be connected adjacently, as shown in FIG. 4, for installation on one side of the outdoor unit 10.

The service valves in the multi-type separation-type air conditioner are configured in such a manner that the service valve comes in a plural form of a pair in the same number as that of the plurality of indoor units, this results in a drawback of all the service valves needing to be inevitably opened or closed when the separation-type air conditioner is installed or detached, respectively.

Another drawback is that if a plurality of service valves must be adjacently installed in a row on one side of the outdoor unit, then the service valves are limited in installation space due to the height of the outdoor unit, and thus manufacturing cost increases due to the installation of plural numbers of service valves.

### SUMMARY

The present invention solves the above-mentioned drawbacks. One advantage described herein is to provide an air conditioner with a service valve assembly, in accordance with an embodiment of the invention, capable of easing the infusion and collection of refrigerant at the time of installation or detachment of a separation-type multi-air conditioner mounted with a plurality of indoor units to thereby reduce manufacturing cost and realize a compact size.

The foregoing and other features, aspects, and advantages will become more apparent from the following detailed description when taken in conjunction with the accompanying drawings.

In one general aspect, an air conditioner with a service valve assembly in accordance with an embodiment of the invention disclosed herein may comprise: an outdoor unit including a compressor and an outdoor heat exchanger; a plurality of indoor units respectively including an expander and an indoor heat exchanger; a plurality of refrigerant input pipes for respectively introducing the refrigerant having passed the plurality of indoor units into the compressor; a first convergence (merger) piping for converging a refrigerant flowing in the plurality of refrigerant input pipes into the compressor; a second convergence piping for diverging and introducing the refrigerant having passed through the outdoor heat exchanger via the compressor into the plurality of indoor units; a plurality of refrigerant supply pipes for separating the refrigerant from the second convergence piping and supplying the refrigerant to the plurality of indoor units; a first service valve interposed between the first convergence piping and the compressor; and a second service valve interposed between the outdoor heat exchanger and the second convergence piping.

The invention may further include one or more of the following features.

The first service valve includes a first refrigerant infuse port, a first port and a second port, where the first service valve is coupled by a first needle valve and switched in directions thereof, and the second service valve includes a second refrigerant infuse port, a third port and a fourth port, where the second service valve is coupled by a second needle valve and switched in directions thereof.

The first service valve is connected to the first convergence piping via the first port and simultaneously is connected to the compressor via the second port, and the second service valve is connected to the second convergence piping via the third port, and simultaneously is connected to the outdoor heat exchanger via the fourth port.

The air conditioner may further include a plurality of refrigerant input ports and a plurality of refrigerant supply ports respectively connected to the plurality of refrigerant input pipes and the plurality of refrigerant supply pipes, both of which are installed on one side of the outdoor unit, where the first convergence piping, the second convergence piping, the first service valve, and the second service valve are adjacently abutted against one surface of the outdoor unit.

The first and second convergence piping are installed inside the outdoor unit, and the first and second service valves are fixedly installed on one surface of the outdoor unit.

The plurality of refrigerant input ports and the plurality of refrigerant supply ports are respectively arranged in parallel.

The air conditioner with a service valve assembly according to the embodiments described herein may be configured with only two service valves, of first and second service valves, to thereby ease the infusion and retrieval of refrigerant using only two service valves at the time of installation or detachment of a separation-type multi-air conditioner mounted with a plurality of indoor units to thereby reduce the manufacturing cost and realize a compact size.

A plurality of refrigerant input ports and refrigerant supply ports are arranged in parallel on one side of an outdoor unit to thereby avoid the positional restriction that occurs when the outdoor unit is installed, and to enable to separate the outdoor unit, allowing the service valve assembly to be installed separately, and resulting in compactness of the outdoor unit and the service valve assembly.

An air conditioner with a service valve assembly according to an embodiment of the invention disclosed herein may include an outdoor unit including a compressor and an outdoor heat exchanger coupled thereto, a plurality of indoor units, each including an expander and an indoor heat exchanger coupled thereto, and a plurality of refrigerant input pipes, each coupled at a first end to a respective one of the plurality of indoor units and each adapted to guide a flow of a refrigerant having passed through the respective one of the plurality of indoor units. It may also include a first convergence piping adapted to converge the refrigerant flowing in the plurality of refrigerant input pipes, having an input adapted to couple to a second end of each of the plurality of refrigerant input pipes and an output coupled to the compressor. It may also include a second convergence piping adapted to diverge the refrigerant having passed through the outdoor heat exchanger via the compressor into the plurality of indoor units. It may further include a plurality of refrigerant supply pipes each coupled at a first end to an output of the second convergence piping and each adapted to guide a flow of a refrigerant to the plurality of indoor units. In accordance with an embodiment of the invention, it may include a first service valve interposed between the first convergence piping and the compressor and a second service valve interposed between the outdoor heat exchanger and the second convergence piping.

An outdoor unit of a separation-type multi-air conditioner system according to an embodiment of the invention may include a quantity of N refrigerant input ports, and a first convergence piping configured to combine a flow of a refrigerant from the N refrigerant input ports to a quantity of M ports, where N>M. It may include a compressor operationally coupled to a heat exchanger, a quantity of X refrigerant output ports, and a second convergence piping configured to diverge the flow of the refrigerant from a quantity of Y ports to a quantity of X ports, where Y<X. It may further include a first service valve including a first needle valve adapted to provide at least three flow patterns between at least a first port coupled to the M ports, a second port coupled to the compressor, and a first refrigerant infuse port. It may also include a second service valve including a second needle valve adapted to provide at least three flow patterns between at least a third port coupled to the Y ports, a fourth port coupled to the heat exchanger, and a second refrigerant infuse port.

### BRIEF DESCRIPTION OF THE DRAWINGS

FIG. 1 is a constituent diagram illustrating a cooling cycle of an air conditioner according to related art.

FIG. 2 is a perspective view illustrating an exterior look of a separation-type air conditioner according to related art.

FIG. 3 is a constituent diagram illustrating a refrigerant circulation system according to an exemplary embodiment of FIG. 2.

FIG. 4 is a side view illustrating a service valve installed on one side of an outdoor unit according to the exemplary embodiment of FIG. 2.

FIG. 5 is a perspective view illustrating an air conditioner disposed with a service valve assembly according to an exemplary embodiment of the invention.

FIG. 6 is a constituent diagram illustrating a refrigerant circulation system according to the exemplary embodiment of FIG. 5.

FIG. 7 is a perspective view, seen from outside, illustrating a service valve assembly disposed at one side of an outdoor unit according to the exemplary embodiment of FIG. 5.

FIG. 8 is a perspective view, seen from the interior, illustrating a service valve assembly disposed at one side of an outdoor unit according to the exemplary embodiment of FIG. 5.

FIGS. 9 to 11 are side views illustrating an operational state of a first service valve according to the exemplary embodiment of FIG. 5.

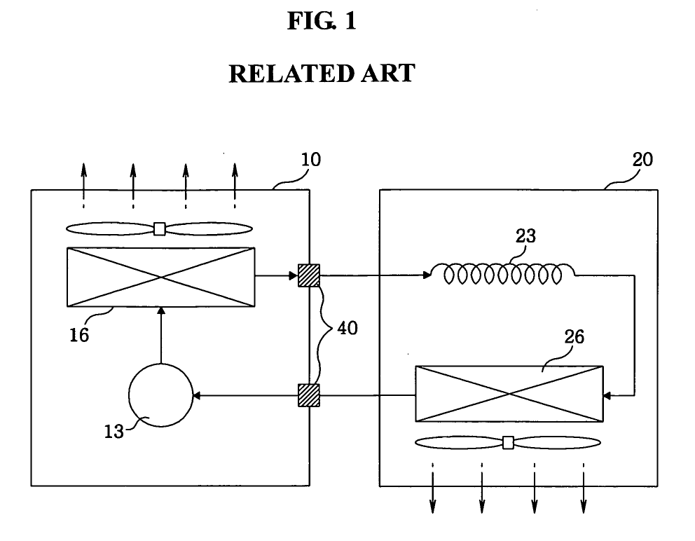

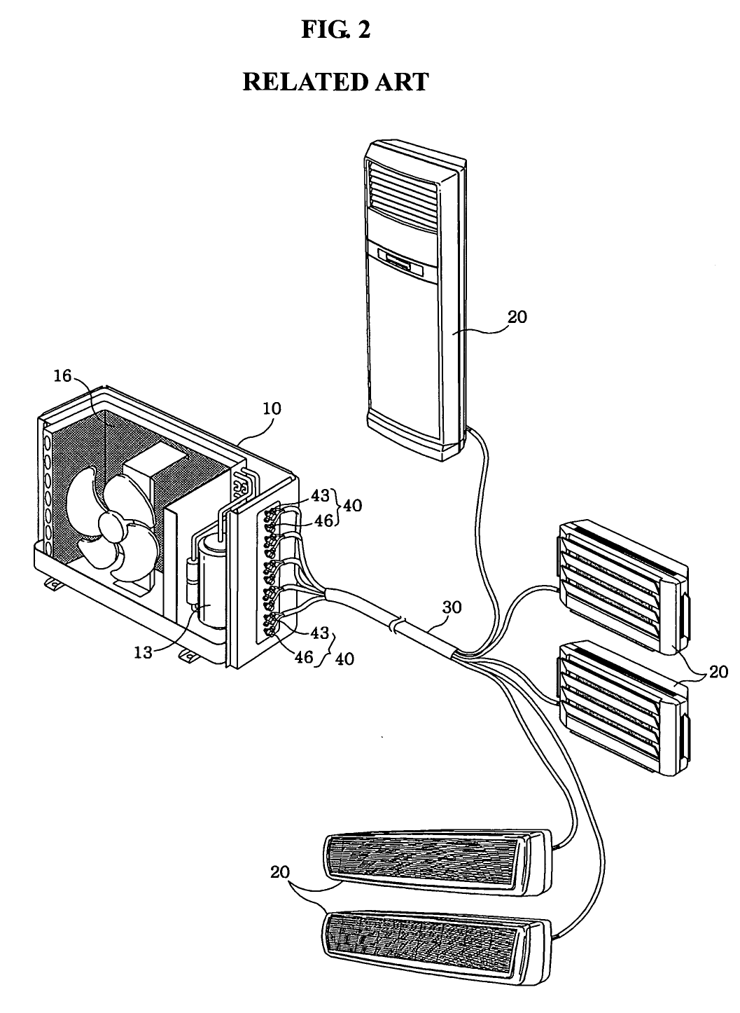

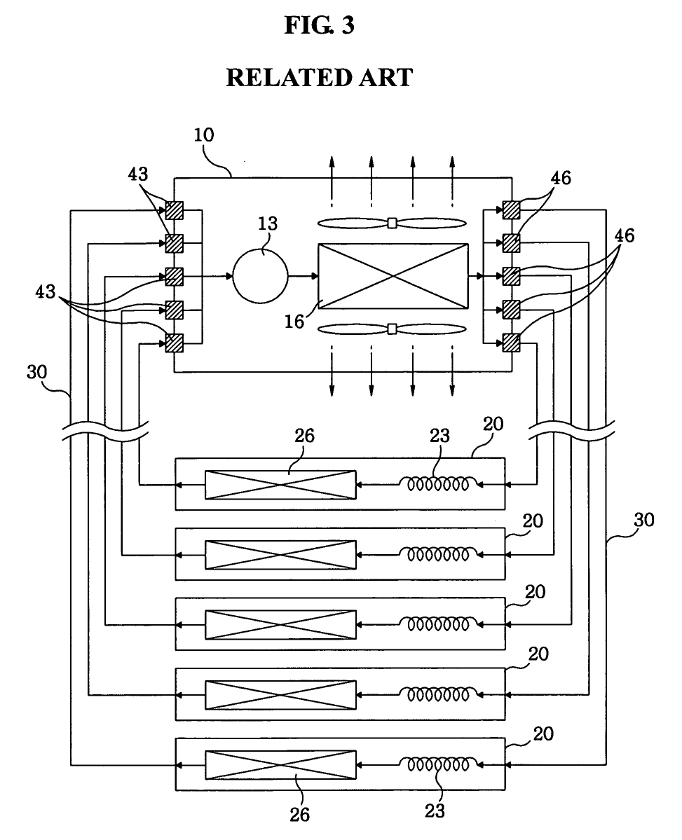

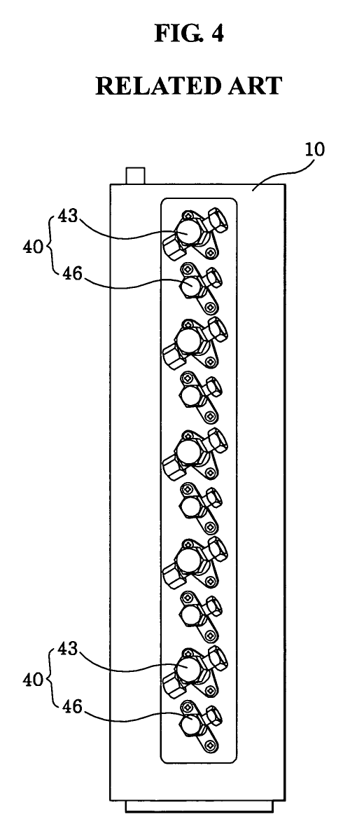

### DETAILED DESCRIPTION OF THE ILLUSTRATED EMBODIMENTS

Now, exemplary embodiments of an air conditioner with service valve assembly according to en embodiment of the invention will be described in detail with reference to the accompanying drawings.

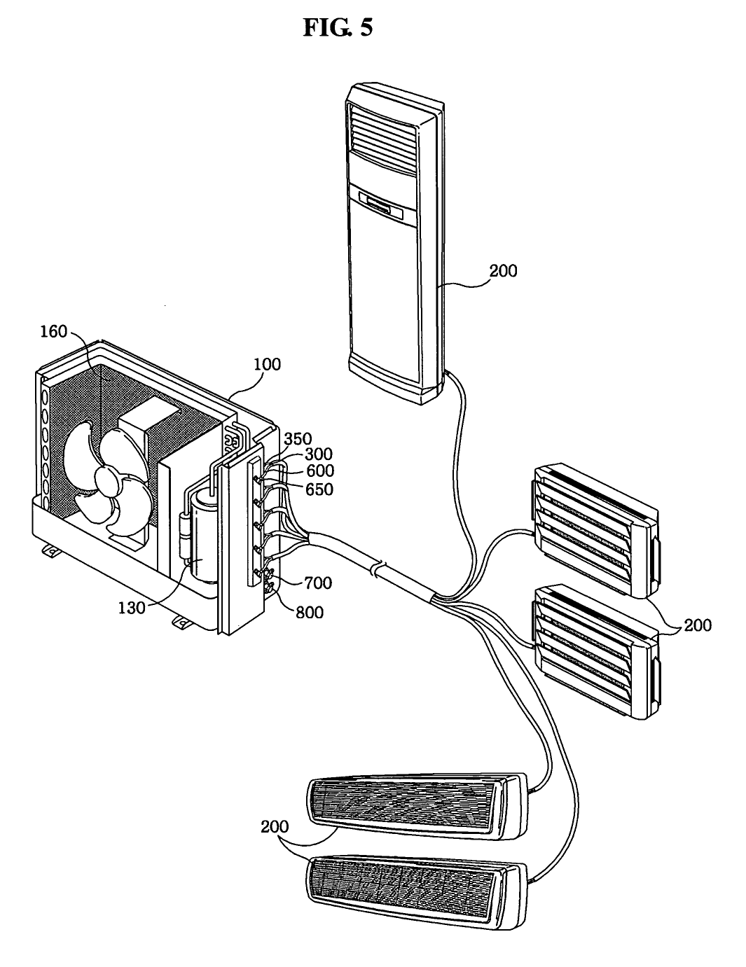

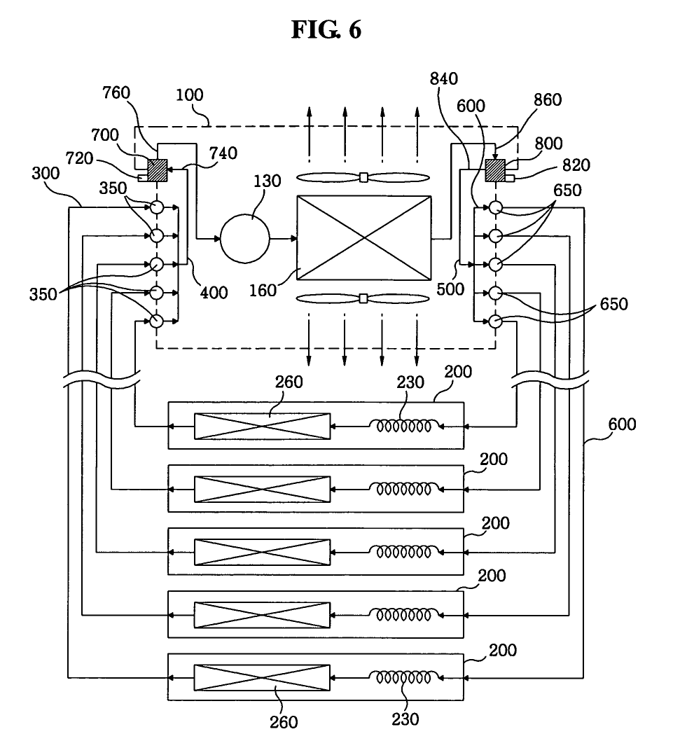

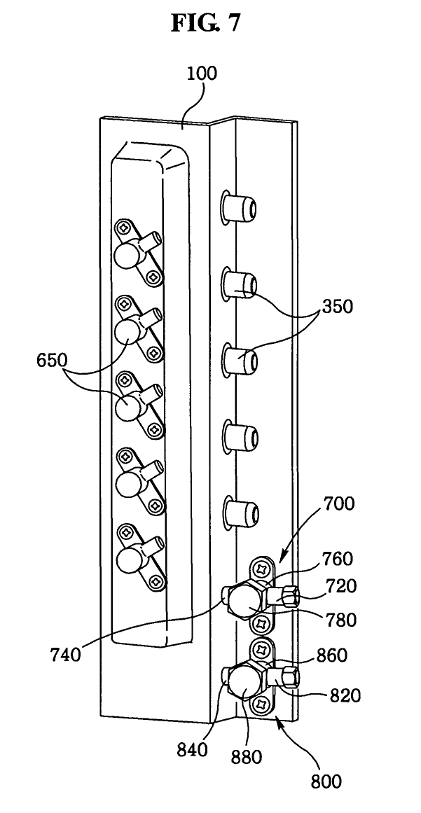

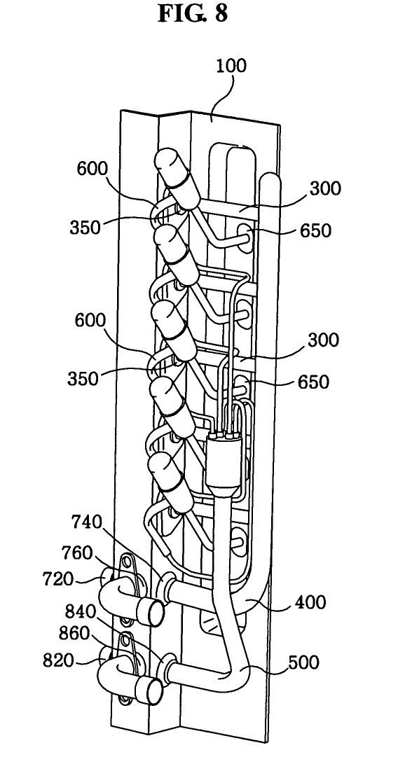

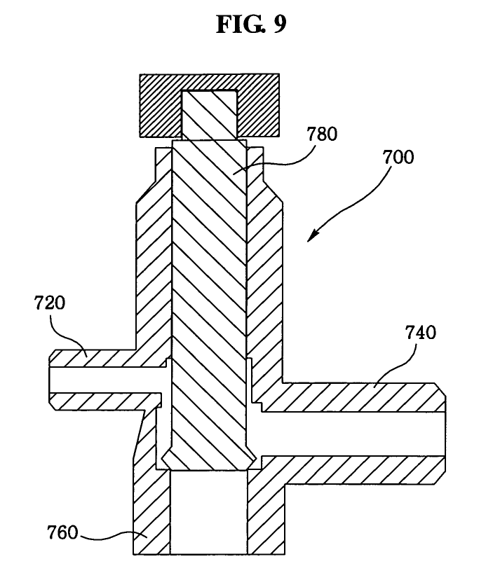

FIG. 5 is a perspective view illustrating an air conditioner disposed with a service valve assembly according to an exemplary embodiment of the invention. FIG. 6 is a constituent diagram illustrating a refrigerant circulation system according to the exemplary embodiment of FIG. 5. FIG. 7 is a perspective view, seen from outside, illustrating a service valve assembly disposed at one side of an outdoor unit according to the exemplary embodiment of FIG. 5. FIG. 8 is a perspective view, seen from the interior, illustrating a service valve assembly disposed at one side of an outdoor unit according to the exemplary embodiment of FIG. 5. FIGS. 9 to 11 are side views illustrating an operational state of a first service valve according to the exemplary embodiment of FIG. 5.

Referring to FIGS. 5 and 6, the air conditioner with service valve assembly may include an outdoor unit 100, an indoor unit 200, a refrigerant input pipe 300, a first convergence piping 400, a second convergence piping 500, a refrigerant supply pipe 600, a first service valve 700 and a second service valve 800.

The outdoor unit 100 further includes a compressor 130 and an outdoor heat exchanger 160 may include at one side thereof a refrigerant input port 350 and a refrigerant supply port 650. The indoor unit 200 may include an expander 230 and an indoor heat exchanger 260. The first service valve 700 may include a first refrigerant infuse port 720, a first port 740, a second port 760 and a first needle valve 780 (FIG. 7). The second service valve 800 may include a second refrigerant infuse port 820, a third port 840, a fourth port 860 and a second needle valve 880 (FIG. 7).

Referring again to FIGS. 5 and 6, the outdoor unit 100 is connectively disposed therein with a compressor 130 and an outdoor heat exchanger 160. The indoor unit 200 may comprise a plural structure, wherein an expander 230 and an indoor heat exchanger 260 are connectively disposed.

Now, assuming that an air conditioner according to an exemplary embodiment described herein is a cooling apparatus, the outdoor heat exchanger 160 may be a condenser, and the indoor heat exchanger 260 may be an evaporator. The air conditioner is operated as a refrigerant goes through a cooling cycle having a series of processes such as a compression process, a condensing process, an expanding process, and an evaporation process. That is, after the refrigerant is compressed to a high temperature and pressure state, heat is discharged to an outer side by the condenser 160. Then, the temperature and pressure of the refrigerant are lowered as it goes through an expander 230. Then, the refrigerant goes through an evaporator 260 to absorb heat and returns to the condenser 160. The evaporator 260 is installed in an indoor unit to absorb heat from the indoor air, thereby maintaining an indoor temperature lower than an outdoor temperature. The outdoor unit 100, the indoor unit 200, and the cooling cycle may be explained in general with reference to the related art such that a detailed explanation thereof is omitted.

A plurality of refrigerant input pipes 300 are disposed to introduce the refrigerant having passed the plurality of indoor units 200 to the compressor 130. The first convergence piping 400 converges the refrigerant flowing through the plurality of refrigerant input pipes 300 and introduces the refrigerant into the compressor 130. In other words, the refrigerant having passed the expander 230 and the indoor heat exchanger 260, respectively, comprising the plurality of indoor units 200 is moved to the compressor 130 through the plurality of refrigerant input pipes 300, where refrigerant having passed the plurality of indoor units 200 through the first convergence piping 400 is converged before being introduced into the compressor 130.

The second convergence piping 500 introduces into the plurality of indoor units 200 the refrigerant that has passed the outdoor heat exchanger 160 through the compressor 130. Furthermore, the refrigerant supply pipe 600 may be formed in plural structures and carries the refrigerant coming from the second convergence pipe 500 to supply the refrigerant to the plurality of indoor units 200. In other words, the refrigerant passes the first convergence pipe 400 via the plurality of refrigerant input pipes 300 from the plurality of indoor units 200 to the compressor 130, and the refrigerant flows in the plurality of refrigerant supply pipes 600 via the outdoor heat exchanger 160 and the second convergence pipe 500 from the compressor 130 and is re-circulated into the plurality of indoor units 200.

The refrigerant is supplied into the outdoor unit 100 and the indoor unit 200 when the outdoor unit 100 and the indoor unit 200 are installed or detached, where the first and second service valves 700, 800, respectively, serve to connect the outdoor unit 100 and the indoor unit 200 for circulation of the refrigerant supplied therein.

Referring to FIGS. 6, 7 and 8, the first service valve 700 is disposed between the first convergence piping 400 and the compressor 130, and the second service valve 800 is disposed between the outdoor heat exchanger 260 and the second convergence piping 500.

Referring back to FIG. 6 for a refrigerant circulation system, firstly, the refrigerant sequentially flows from the plurality of indoor units 200, the plurality of refrigerant input pipes 300, the first convergence piping 400, the first service valve 700, and through to the compressor 130, and then, the refrigerant sequentially flows from the compressor 130 to the outdoor heat exchanger 160, the second service valve 800, the second convergence piping 500, the plurality of refrigerant supply pipes 600 and again to the indoor unit 200.

As illustrated in the exemplary embodiments described herein, only the first convergence piping 400 and the second convergence piping 500, along with the pair of the first service valve 700 and second service valve 800, are installed to thereby depart from the conventional method of installing as many first and second service valves 700, 800 as the indoor units 200. Hence, only the first service valve 700 and the second service valve 800 are opened and closed at the time of installation and detachment of the outdoor unit 100 and indoor units 200 without recourse to opening and closing the plurality of service valves according to the conventional method, making it easy to install and detach the separation-type air conditioner, dispensing with the need of installing a large number of service valves, and thereby reducing the manufacturing cost.

Now, referring to FIGS. 9, 10 and 11, the first service valve 700 and the second service valve 800 (FIGS. 5, 6, 7) are three-way valves, where the first service valve may include a first refrigerant infuse port 720, a first port 740 and a second port 760, and a first needle valve 780 is coupled thereto for switching directions.

Furthermore, the second service valve 800 may include a second refrigerant infuse port 820, a third port 840 and a fourth port 860, and a second needle valve 880 is coupled thereto for switching directions.

Various kinds of service valves may be used. In one embodiment, as illustrated herein, three-way valves may be used. In other words, the first service valve 700 is configured in such a fashion that the first refrigerant infuse port 720 takes up one direction into which the refrigerant is introduced, while the first port 740 and the second port 760 each assume one direction for selective openness for the flow path. The second service valve 800 may be the same as the first service valve in terms of construction and function.

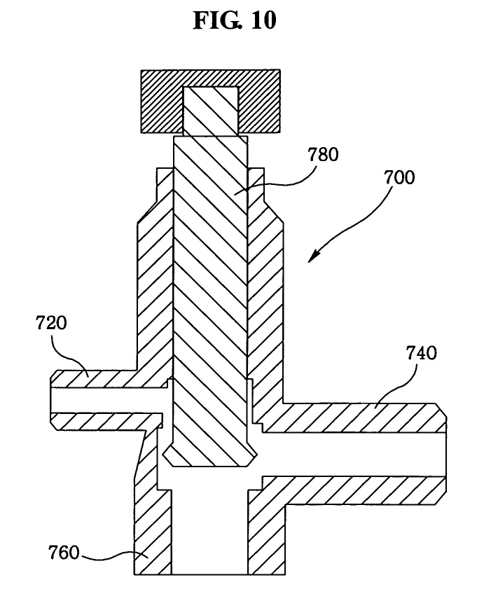

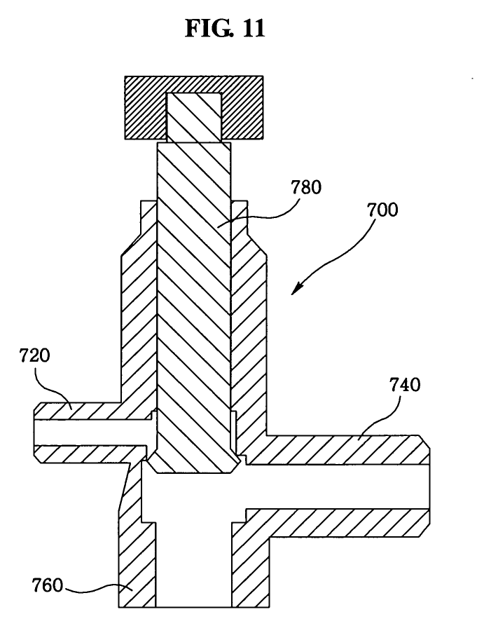

The service valve responds by assuming one of three states: a closed state as in FIG. 9; an air vent state as in FIG. 10; or an open state as in FIG. 11, where the refrigerant infuse port 720, the first port 740 and the second port 760 selectively opens or closes in response to the rotation of the needle valve 780.

Furthermore, the first service valve 700 is connected to the first convergence piping 400 via the first port 740, and connected to the compressor 130 via the second port 760. The second service valve 800 is connected to the second convergence piping 500 via the third port 840, and connected to the outdoor heat exchanger 160 via the fourth port 860. The construction and function of three-way valves are known in the art such that a detailed description thereof may be omitted herein.

Meanwhile, the service valve assembly may be separately installed from one surface of the outdoor unit 100 or from the outdoor unit 100. However, in case the service valve assembly is installed on one surface of the outdoor unit 100, the plurality of refrigerant input ports 350 and the plurality of refrigerant supply ports 650 are installed on one surface of the outdoor unit 100 to which the plurality of refrigerant infuse pipes 300 and the plurality of refrigerant supply pipes 600 are respectively connected.

Furthermore, the first convergence piping 400, the second convergence piping 600, the first service valve 700 and the second service valve 800 may be adjacently installed on said one surface of the outdoor unit 100. The first convergence piping 400 and the second convergence piping 500 may be installed inside the outdoor unit 100, where the first service valve 700 and the second service valve 800 may be installed on said one surface of the outdoor unit 100.

In case the service valve assembly is separately installed from one surface of the outdoor unit 100 or from the outdoor unit 100, the refrigerant circulation system in which all the refrigerant circulates is substantially the same, except that installation positions thereof may be different.

Particularly, in case the service valve assembly is separately installed from one surface of the outdoor unit 100, the plurality of refrigerant infuse port 350 and the plurality of refrigerant supply ports 650 may be respectively arranged in parallel, whereby the positional restriction may be avoided when the outdoor unit 100 is installed, and the service valve assembly may be separately installed from the outdoor unit 100, thereby making it possible to reduce the size of the outdoor unit 100 and the service valve assembly.

The air conditioner with a service valve assembly according to an embodiment of the present invention may be configured with only two service valves (i.e., first and second service valves), to thereby ease the infusion and collection of refrigerant by way of using the two service valves at the time of installation or detachment of a separation-type multi-air conditioner mounted with a plurality of indoor units to thereby reduce the manufacturing cost and realize a compact size.

A plurality of refrigerant input ports and refrigerant supply ports may be arranged in parallel on one surface of an outdoor unit to thereby avoid the positional restriction that occurs when the outdoor unit is installed, and to enable one to separate the outdoor unit, allowing the service valve assembly to be installed separately, and resulting in a compact size of the outdoor unit and the service valve assembly.

Although the above-described embodiments may be realized in several forms without departing from the spirit, essential characteristics thereof, or scope of the invention, it should also be understood that the embodiments are not limited by any of the details of the foregoing description, unless otherwise specified, but rather should be construed broadly within its spirit and scope as defined in the appended claims, and therefore those skilled in the art will appreciate that all changes and modifications that fall within the metes and bounds of the claims, or equivalence of such metes and bounds are therefore intended to be embraced by the appended claims.

What is claimed is:

1. An air conditioner with a service valve assembly comprising:
an outdoor unit including a compressor and an outdoor heat exchanger coupled thereto;
a plurality of indoor units, each including an expander and an indoor heat exchanger coupled thereto;
a plurality of refrigerant input pipes, each coupled at a first end to a respective one of the plurality of indoor units and each adapted to guide a flow of a refrigerant having passed through the respective one of the plurality of indoor units;
a first convergence piping adapted to converge the refrigerant flowing in the plurality of refrigerant input pipes, having an input adapted to couple to a second end of each of the plurality of refrigerant input pipes and an output coupled to the compressor;
a second convergence piping adapted to diverge the refrigerant having passed through the outdoor heat exchanger via the compressor into the plurality of indoor units;
a plurality of refrigerant supply pipes each coupled at a first end to an output of the second convergence piping and each adapted to guide a flow of a refrigerant to the plurality of indoor units;
a first service valve interposed between the first convergence piping and the compressor; and
a second service valve interposed between the outdoor heat exchanger and the second convergence piping.

2. The air conditioner with a service valve assembly as claimed in claim 1, wherein:
the first service valve comprises:
a first refrigerant infuse port,
a first port, and
a second port, wherein the first service valve comprises a first needle valve adapted to switch the flow of refrigerant between the first refrigerant infuse port, the first port, and the second port; and
the second service valve comprises:
a second refrigerant infuse port,
a third port, and
a fourth port, wherein the second service valve comprises a second needle valve adapted to switch the flow of refrigerant between the second refrigerant infuse port, the third port, and the fourth port.

3. The air conditioner with a service valve assembly as claimed in claim 2, wherein:
the first service valve is connected to the first convergence piping via the first port and simultaneously is connected to the compressor via the second port; and
the second service valve is connected to the second convergence piping via the third port, and simultaneously is connected to the outdoor heat exchanger via the fourth port.

4. The air conditioner with a service valve assembly as claimed in claim 1, further comprising a plurality of refrigerant input ports and a plurality of refrigerant supply ports respectively connected to the plurality of refrigerant input pipes and the plurality of refrigerant supply pipes, wherein:
the outdoor unit is comprised of a plurality of sides that separate an interior of the outdoor unit from an exterior surface of the outdoor unit,
both the plurality of refrigerant input ports and the plurality of refrigerant supply ports are mounted on one surface of the plurality of sides of the outdoor unit, and
the first convergence piping, the second convergence piping, the first service valve, and the second service valve are adjacently mounted on the one surface of the plurality of sides of the outdoor unit.

5. The air conditioner with a service valve assembly as claimed in claim 4, wherein the first and second convergence pipings are mounted to an interior surface of the outdoor unit, and the first and second service valves are mounted to an exterior surface of the outdoor unit.

6. The air conditioner with a service valve assembly as claimed in claim 4, wherein the plurality of refrigerant input ports and the plurality of refrigerant supply ports are respectively arranged in parallel.

7. The air conditioner with a service valve assembly as claimed in claim 4, wherein the plurality of refrigerant input ports, the plurality of refrigerant supply ports, the first service valve, and the second service valve are mounted on one side of the plurality of sides of the outdoor unit.

8. The air conditioner of claim 1, wherein the air conditioner is a separation-type multi-air conditioner.

9. An outdoor unit of a separation-type multi-air conditioner system, comprising:
a quantity of N refrigerant input ports;
a first convergence piping configured to combine a flow of a refrigerant from the N refrigerant input ports to a quantity of M ports, where N>M;
a compressor operationally coupled to a heat exchanger;
a quantity of X refrigerant output ports;
a second convergence piping configured to diverge the flow of the refrigerant from a quantity of Y ports to a quantity of X ports, where Y<X;
a first service valve including a first needle valve adapted to provide at least three flow patterns between at least a first port coupled to the M ports, a second port coupled to the compressor, and a first refrigerant infuse port; and
a second service valve including a second needle valve adapted to provide at least three flow patterns between at least a third port coupled to the Y ports, a fourth port coupled to the heat exchanger, and a second refrigerant infuse port.

10. The outdoor unit of claim 9, wherein M=1.

11. The outdoor unit of claim 9, wherein Y=1.

12. The outdoor unit of claim 9, wherein N=X.

13. The outdoor unit of claim 9, wherein M=Y.

14. The outdoor unit of claim 9, wherein the first service valve:
operationally couples the first refrigerant infuse port to the N refrigerant input ports via the first port;
operationally couples the first refrigerant infuse port to both the N refrigerant input ports and the compressor via the first and second ports, respectively; or
operationally couples the N refrigerant input ports, via the first port, to the compressor, via the second port.

15. The outdoor unit of claim 9, wherein the second service valve:
operationally couples the second refrigerant infuse port to the X refrigerant output ports via the third port;
operationally couples the second refrigerant infuse port to both the X refrigerant output ports and the heat exchanger via the third and fourth ports, respectively; or
operationally couples the X refrigerant output ports, via the third port, to the heat exchanger, via the fourth port.

16. The outdoor unit of claim 9, wherein at least one of the N refrigerants input ports is valveless.

17. The outdoor unit of claim 9, wherein at least one of the X refrigerants output ports is valveless.
